(19) United States
(12) Patent Application Publication
(10) Pub. No.: US 2007/0254522 A1
(43) Pub. Date: Nov. 1, 2007

(54) Strain relief device

(76) Inventor: Robert A. Libby, Williamsport, PA (US)

Correspondence Address: Thomas R. Shaffer, 5 East Third Street, PO Box 509, Coudersport, PA, 16915, US

(21) Appl. No.: 11/416,011

(22) Filed: May 1, 2006

(51) Int. Cl. H01R 13/58

(52) U.S. Cl. 439/456

(57) ABSTRACT

A strain relief device is disclosed for securely holding a wire in a manner restraining the wire from being pulled longitudinally out of a housing. The housing has an opening therein extending along a longitudinally axis from a mouth portion to a chamber bottom. The opening has a narrow mouth portion sized large enough to receive a wire and a chamber portion located deeper in the opening and sized significantly larger than said mouth portion. A strain relief member is positioned in the chamber portion near the location of a junction of the mouth portion and the chamber portion along a first side of a wire inserted into the opening. The strain relief member provides a structure around which a wire inserted into the opening may be bent from a straight wire to a wire having at least one angled bend therein. A wire bending member is movable from a first position located outside of the opening to a second position located inside said opening. As the wire bending member moves from the first position to the second position, the wire bending member applies force to an opposite side of the wire at a location on the wire deeper in the chamber which causes the wire to bend around the strain relief member.

### SUMMARY OF THE INVENTION

1. Field of the Invention

The present invention relates to a strain relief device. More specifically, it relates to a strain relief device in which an angled bend is imparted to a wire to resist against a longitudinal pullout thereof.

2. Description of the Prior Art

A large number of prior art patents have been proposed which describe various strain relief devices. Most of these prior art devices rely on some kind of the gripping or pinching of a wire or cable tube provided a fictional engagement of the wire in a desired location. Examples of a few of these devices include U.S. Pat. Nos. 6,238,236; 6,310,290; 6,706,970; and 6,863,567. Applicant's earlier U.S. Pat. No. 5,785,551 teaches the provision of a gripping member 72 which is crimped onto the cable to prevent a longitudinal pullout. Applicant's earlier U.S. Pat. No. 5,975,938 teaches the provision of ridges 34 to provide fictional engagement with a cable inserted into a housing.

U.S. Pat. No. 6,625,849 teaches a cable strain relief device which has a retainer having a slot for receiving a cable. A clip has any projection receivable in the slot to bear against the cable and hold the same to the retainer.

U.S. Pat. No. 5,626,491 discloses an electrical connector strain relief for a ribbon cable which teaches the provision of a cable loop 50 and rod 46 which trap the cable in a recess.

U.S. Pat. No. 4,802,864 discloses a right angle housing which is used as a strain relief device. The housing 100 may be utilized at the factory or in the field. A cable is manually inserted into the housing. The housing is molded from a polyester elastomer having a high coefficient of friction.

None of the prior art devices teach or suggest the provision of a wire bending member in combination with a strain relief member to place an angled bend into a wire. Further, none of the prior art devices teach the concept of utilizing the resistance created by a bend in a wire as a means to resist, restrain or ideally prevent a longitudinal pullout of a wire from a housing or the like.

### SUMMARY OF THE INVENTION

In its simplest form, the present invention provides a strain relief device for securely holding a wire in a manner restraining the wire from being pulled longitudinally away from a strain relief member comprising: a) a strain relief providing a structure around which a wire may be bent from a straight wire to a wire having at least one angled bend therein; and b) a wire bending member movable from a first position to a second position whereby, as said wire bending member moves from said first position to said second position, the wire bending member applies force to said wire causing said wire to bend around said strain relief member.

Preferably, said strain relief device further comprises a housing, said housing having an opening therein extending along a longitudinally axis from a mouth portion to a chamber bottom, said opening having a narrow mouth portion sized large enough to receive a wire and said opening having a chamber portion located deeper in said opening and sized significantly larger than said mouth portion, said strain relief member positioned in said chamber portion near the location of a junction of the mouth portion and the chamber portion along a first side of a wire inserted into said opening, said wire bending member movable from said first position located outside of said opening to said second position located inside said opening wherein as said wire bending member moves from said first position to said second position, the wire bending member applies force to an opposite side of said wire at a location on said wire deeper into said chamber causing said wire to bend around said strain relief member.

Preferably, said bend in the wire, said strain relief member and said wire bending member each provide resistance against a longitudinal removal of said wire after said wire bending member is in said second position.

Preferably, said wire bending member and said chamber cooperate to cause said wire to bend at two locations forming a generally s-shaped configuration.

Preferably, said wire bending member has a leading edge in the form of the wedge and utilizes the principal of an inclined plane to apply force to said opposite side of said wire.

Preferably, said housing has an opening therein sized to receive at least two wires therein. Preferably, said housing has an opening therein sized to receive an unstripped end of an insulated electrical cable of the type having an outer sheath within which at least an insulated hot wire, an insulated neutral wire and a ground wire are enclosed.

Preferably, said housing further comprises a body formed of an electrically insulating material, said body containing said chamber and a lid which is pivotally connected to the body and is adapted to rotate around an axis of rotation between an open position and a closed position.

In one embodiment of the invention, said strain relief member is in the form of angled intersection of a mouth side wall of the mouth portion and a chamber side wall of the chamber portion. With this embodiment, said angled intersection is between 90 degrees and 175 degrees and preferably approximately 135 degrees.

In one preferred embodiment of the invention, said wire bending member moves transversely relative to said wire when moved from said first position to said second position. In another embodiment, said wire bending member moves longitudinally relative to said wire when moved from said first position to said second position.

Preferably, said strain relief member is in the form of a post. In one preferred embodiment, said post has a generally square cross section. In another embodiment, said post has a generally circular cross section.

In one embodiment, said post has a top cap and a bottom cap and has a central channel portion sized and configured to grip said first side of said wire which whereby applying outward longitudinal force on said wire causes said first side of said wire to be forced deeper into said channel thereby increasing the grip on said wire. With this embodiment, preferably a deepest part of said channel portion has a width which is narrower than a diameter of said wire.

Preferably, said wire is rigid.

### BRIEF DESCRIPTION OF THE FIGURES

FIG. 1 is a cross-sectional view showing the housing of the present invention with a wire bending member (not shown) in a first position.

FIG. 2 is a cross-sectional view showing the embodiment of FIG. 1 with a wire bending member in a second position in the housing.

FIG. 3 is a cross-sectional view of the preferred embodiment of the housing of the present invention having an unstripped end of an electrical cable therein.

FIG. 4 is a perspective cross-sectional view of the preferred embodiment of the invention.

FIG. 5 is a perspective view showing a body and lid portion of the housing for the preferred embodiment of the invention.

FIG. 6 is a perspective view of another embodiment of the invention showing a wire bending member which moves transversely relative to the wire.

FIG. 7 is a perspective view of yet another embodiment of the invention showing a wire bending member which moves longitudinally relative to the wire.

### DETAILED DESCRIPTION OF THE PREFERRED EMBODIMENTS

Referring to the figures, a housing 10 is provided which includes a body 11, a first side 12, a second end 14, a first side 16 and a second side 18. A housing 10 has an opening 20, 22 which extends longitudinally from a mouth 20 to a chamber portion 22. The mouth 20 is sized slightly larger than the diameter of a wire or cable 50 which is adapted to be inserted therein. The chamber 22 is sized to be much larger than the diameter of the wire or cable 50. As is shown, end 56 of a straight wire 50 is inserted through the mouth 20 and into the chamber 22. The housing 10 preferably has an angled bend 24 therein around which the wire 50 may be bent. This angled bend 24 is preferably bent at an angle of 135°. The housing 10 preferably also has an angled bend 26 therein into which the wire 50 may be bent to cause a second bend in the wire. This angled bend 26 is also preferably bent at an angle of 135°.

The present invention is adapted to be utilized with a variety of different types of wire or cable. As will be understood by those skilled in the art, the more rigid the wire or cable which is inserted into the chamber 22, the greater the resistance to a longitudinal pullout will be achieved by placing a bend in the wire. While the present invention will work to some degree in any wire, it is specifically designed to be utilized in connection with electrical cable utilized in homes, businesses and commercial facilities for transmission of 110 and 220 volt electrical services. One example of such a cable is sold under the trade name Romex. Such cables are insulated electrical cables of the type having an outer sheath within which at least an insulated hot wire, an insulated neutral wire and a ground wire are enclosed. It will also be obvious that the use of a thin braded wire designed for low voltage electronics would offer little resistance to a pullout compared to thicker more rigid cables. As used in the claims, the term rigid wire would include any wire or cable capable of safely transmitting 110 volts or more of electricity to provide electric power to a home or business. Preferably, a rigid wire is a wire of the type used in Romex cables and the like.

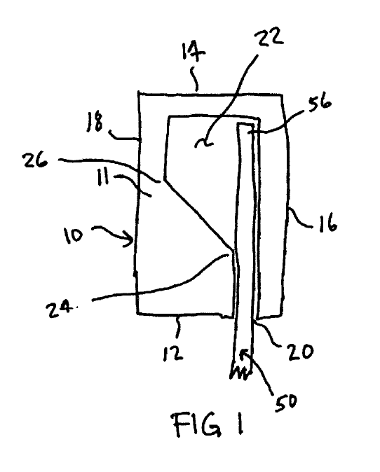

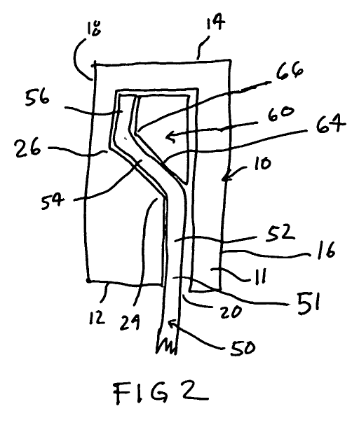

Referring now to FIG. 2, the embodiment of the invention shown in FIG. 1 is shown having a wire bending member 60 in a second position. The wire bending member 60 has an inclined edge 64 which when moved transversely downwardly relative to the wire 50 causes said wire 50 to be bent around angled bend 24 and around angled bend 26. It will be obvious that the angled bend 66 of the wire bending member 60 cooperates with the angled bend 26 of the body 11 to create a second bend in the wire 50. As shown, a first portion 51 of wire 50 does not move and remains in the same position as in FIG. 1. A second middle portion 54 of wire 50 is caused to be bent at an angle of approximately 135° relative to the first portion. A third end portion 56 of wire 15 is also bent at approximately 135° relative to the middle portion 54. Preferably, first portion 51 and third portion 56 are parallel to one another. Once the wire bending member 64 is in the second position as shown in FIG. 2, the wire 50 essentially has an s-shaped configuration which is confined to an s-shaped channel formed cooperatively by said body 11 and said wire bending member 60. The effect of such design is that the bends in the wire 50 offer resistance to a longitudinal pullout of wire 50 because in order to remove said wire from the housing 10 would require the wire 50 to be essentially straightened before it could be pulled out of the housing. When a rigid wire 50 is utilized, a significant resistance against longitudinal pullout is achieved.

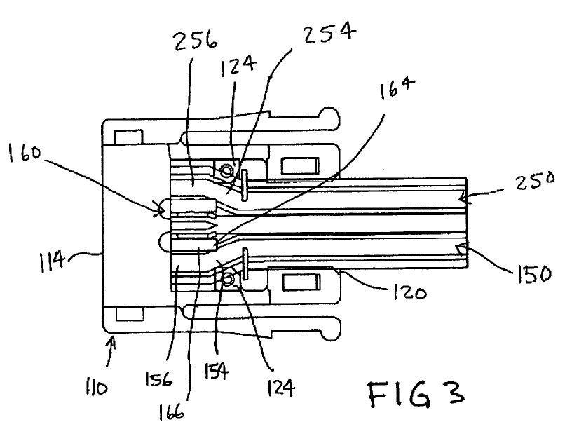

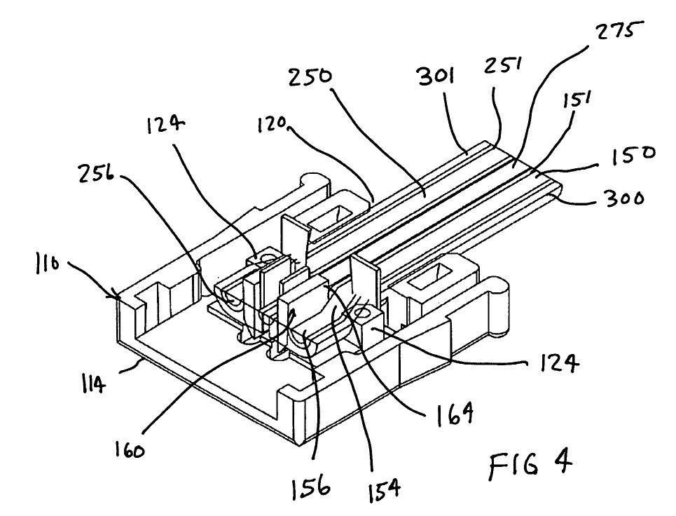

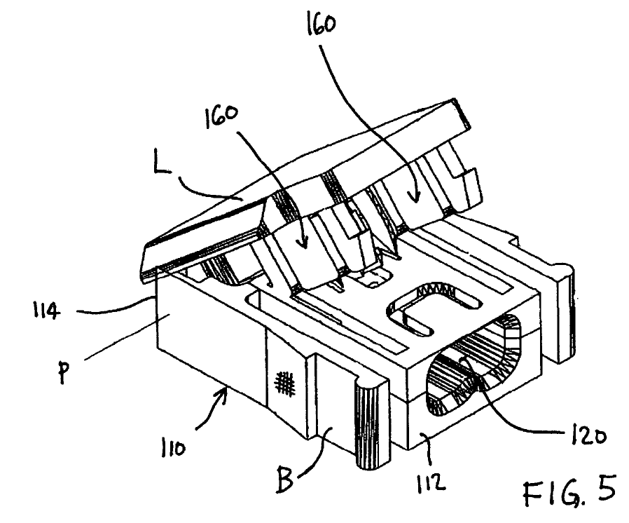

Referring to FIGS. 3, 4 and 5, the preferred embodiment of the present invention is shown. A housing 110 includes a body B and a lid L. The lid L, which includes two wire bending members 160, is adapted to pivotally move around an axis P from a first open position as shown in FIG. 5 to a second closed position. The wire bending members 160 are shown with the lid L in the second closed position in FIGS. 3 and 4. For the sake of visual clarity, the only portion of the lid L which is shown in FIGS. 3 and 4 is the wire bending members 160 themselves.

The housing 110 includes a first end 112 and a second end 114. The first end 112 has an opening 120 therein adapted to receive a transversely cut, unstripped end of an electrical cable 300. Cable 300 includes a first hot wire 150, a second neutral wire 250 and a third ground wire 275. The first hot wire 150 has an insulating cover 151 and the second neutral wire 250 has an insulating cover 251. The wires 150, 250 and 275 are covered by an insulating sheath 301. In this preferred embodiment of the invention, the wire bending members 160 have a wedge shaped bottom as is best shown in FIG. 4. The wedge shaped bottom causes the second portion 154 and third portion 156 of wire 150 to be bent as shown in FIGS. 3 and 4. Similarly, middle portion 254 and third portion 256 of wire 250 are likewise bent. Wires 150 and 250 are each bent around a strain relief member 224 in a form of a post which has a generally square cross-sectional configuration.

While not the subject of the present patent application, it is noted that the embodiment of the invention shown in FIGS. 3, 4 and 5 can also be utilized to make an electrical connection to the electrical cable 300. The details of such a device are disclosed in applicant's co-pending patent application which has been published under patent application publication number US 2005/0064759 A1.

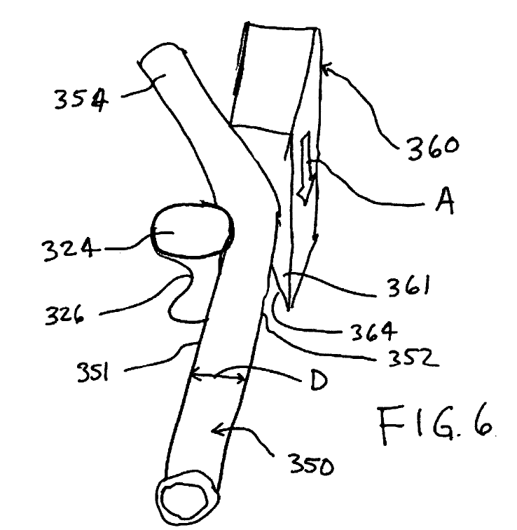

Referring to FIG. 6, the invention is shown in one of its simplest forms. A wire 350 which has a diameter D and has a first end 351 and a second end 357 is provided. A strain relief member 324 is provided around which the wire 350 is adopted to be bent. Strain relief member 324 has a central portion 326 which is narrower than the diameter of the air 350. This increases a frictional grip which the stain relief member 324 has on the wire as the wire essentially becomes wedged into the narrow portion 326 as it is bent around the strain relief member 324. End 354 is bent relative to end 351 by means of a wire bending member 360 which moves transversely relative to wire 350 in the direction of arrow A from a first position above the wire 350 to a second position as shown in FIG. 6. A lower end 361 of the wire bending member 350 has an inclined surface 364 thereon and causes the wire bending member 350 to act as a wedge. For the invention to operate, it is necessary for the strain relief member 324 to be held in a firm and rigid position and for the wire bending member 360 to move relative to the strain relief member 324. It is preferable but not required that the strain relief member 324 be mounted in a suitable housing (not shown).

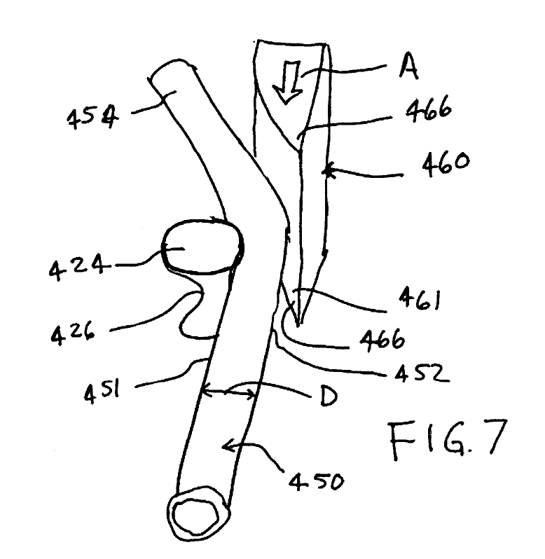

FIG. 7 shows an embodiment of the invention similar to FIG. 6. In FIG. 7, however, the wire bending member 460 moves longitudinally relative to the wire 450 rather than transversely as is the case with the embodiment shown in FIG. 6. For the sake of convenience, the reference numbers in FIG. 7 correspond to similar components of FIG. 6 but with the FIG. 7 numbers each being 100 greater. For example, wire 350 in FIG. 6 corresponds with wire 450 in FIG. 7. In FIG. 7, the wire bending member 460 moves longitudinally relative to wire 450 in the direction of arrow A from a first position more distant from strain relief member 424 to a second position closer to strain relief member 424 as shown in the figure. Such movement causes the wire 450 to be bent at an angle of approximately 135°.

The invention having been disclosed in connection with the foregoing variations and examples, additional variations will now be apparent to persons skilled in the art. The invention is not intended to be limited to the variations specifically mentioned, and accordingly, reference should be made to the appended claims rather than the foregoing discussion of preferred examples to assess the scope of the invention in which exclusive rights are claimed.

I claim:

1. A strain relief device for securely holding a wire in a manner restraining the wire from being pulled longitudinally away from a strain relief member comprising:
a) a strain relief member providing a structure around which a wire may be bent from a straight wire to a wire having at least one angled bend therein; and
b) a wire bending member movable from a first position to a second position whereby, as said wire bending member moves from said first position to said second position, the wire bending member applies force to said wire causing said wire to bend around said strain relief member.

2. A strain relief device according to claim 1 further comprising a housing, said housing having an opening therein extending along a longitudinally axis from a mouth portion to a chamber bottom, said opening having a narrow mouth portion sized large enough to receive a wire and said opening having a chamber portion located deeper in said opening and sized significantly larger than said mouth portion, said strain relief member positioned in said chamber portion near the location of a junction of the mouth portion and the chamber portion along a first side of a wire inserted into said opening, said wire bending member movable from said first position located outside of said opening to said second position located inside said opening wherein as said wire bending member moves from said first position to said second position, the wire bending member applies force to an opposite side of said wire at a location on said wire deeper into said chamber causing said wire to bend around said strain relief member.

3. A strain relief device according to claim 1 whereby said bend in the wire, said strain relief member and said wire bending member each provide resistance against a longitudinal removal of said wire after said wire bending member is in said second position.

4. A strain relief device according to claim 2 wherein said wire bending member and said chamber cooperate to cause said wire to bend at two locations forming a generally s-shaped configuration.

5. A strain relief device according to claim 1 wherein said wire bending member has a leading edge in the form of the wedge and utilizes the principal of an inclined plane to apply force to said opposite side of said wire.

6. A strain relief device according to claim 2 wherein said housing has an opening therein sized to receive at least two wires therein.

7. A strain relief device according to claim 2 wherein said housing has an opening therein sized to receive an unstripped end of an insulated electrical cable of the type having an outer sheath within which at least an insulated hot wire, an insulated neutral wire and a ground wire are enclosed.

8. A strain relief device according to claim 2 wherein said housing further comprises a body formed of an electrically insulating material, said body containing said chamber and a lid which is pivotally connected to the body and is adapted to rotate around an axis of rotation between an open position and a closed position.

9. A strain relief device according to claim 2 wherein said strain relief member is in the form of angled intersection of a mouth side wall of the mouth portion and a chamber side wall of the chamber portion.

10. A strain relief device according to claim 9 wherein said angled intersection is between 90 degrees and 175 degrees.

11. A strain relief device according to claim 9 wherein said angled intersection is approximately 135 degrees.

12. A strain relief device according to claim 1 wherein said wire bending member moves transversely relative to said wire when moved from said first position to said second position.

13. A strain relief device according to claim 1 wherein said wire bending member moves longitudinally relative to said wire when moved from said first positioned to said second position.

14. A strain relief device according to claim 1 wherein said strain relief member is in the form of a post.

15. A strain relief device according to claim 14 wherein said post has a generally square cross section.

16. A strain relief device according to claim 14 wherein said post has a generally circular cross section.

17. A strain relief device according to claim 14 wherein said post has a top cap and a bottom cap.

18. A strain relief device according to claim 14 wherein said post has a central channel portion sized and configured to grip said first side of said wire which whereby applying outward longitudinal force on said wire causes said first side of said wire to be forced deeper into said channel thereby increasing the grip on said wire.

19. A strain relief device according to claim 18 wherein a deepest part of said channel portion has a width which is narrower than a diameter of said wire.

20. A strain relief device according to claim 1 wherein said wire is rigid.
